(19) United States
(12) Patent Application Publication
(10) Pub. No.: US 2015/0302650 A1
(43) Pub. Date: Oct. 22, 2015

(54) Methods and Systems for Providing Procedures in Real-Time

(71) Applicants: Hazem M. Abdelmoati, Doha (QA); Eng Tat Khoo, Singapore (SG); Dennis Cafiero, Toms River, NJ (US); Ying-Chieh Huang, Berkeley Heights, NJ (US)

(72) Inventors: Hazem M. Abdelmoati, Doha (QA); Eng Tat Khoo, Singapore (SG); Dennis Cafiero, Toms River, NJ (US); Ying-Chieh Huang, Berkeley Heights, NJ (US)

(21) Appl. No.: 14/676,299

(22) Filed: Apr. 1, 2015

Related U.S. Application Data
(60) Provisional application No. 61/980,474, filed on Apr. 16, 2014.

(51) Int. Cl. G06T 19/00; G06F 3/0488; G06F 3/0481; G06F 3/041

(52) U.S. Cl. CPC G06T 19/006; G06F 3/041; G06F 3/0488; G06F 3/04815

(57) ABSTRACT

Systems and methods for providing users with an augmented view of a work environment are provided. The method includes downloading data relevant to a component in the work environment onto a mobile device. The work environment is navigated to locate the component based on prompts provided by the mobile device. An augmented reality (AR) marker located proximate to the component is scanned with the mobile device to access interactive procedures relevant to the component. One or more of the interactive procedures are performed.

### CROSS-REFERENCE TO RELATED APPLICATION

This application claims the benefit of U.S. Provisional Application No. 61/980,474, filed Apr. 16, 2014, entitled METHODS AND SYSTEMS FOR PROVIDING PROCEDURES IN REAL-TIME, the entirety of which is incorporated by reference herein.

### FIELD

The present disclosure generally relates to providing users with procedures. Particularly, the present disclosure provides users with interactive procedures in a real-time display of a work environment.

### BACKGROUND

This section is intended to introduce various aspects of the art, which may be associated with exemplary embodiments of the present disclosure. This description is believed to assist in providing a framework to facilitate a better understanding of particular aspects of the present disclosure. Accordingly, it should be understood that this section should be read in this light, and not necessarily as admissions of prior art.

Hydrocarbon usage is a fundamental aspect of current civilization. Facilities for the production, processing, transportation, and use of hydrocarbons continue to be built in locations around the world. Thus, as the efficiency of these facilities become increasingly important, facility users must become quickly familiarized with the facilities and all of its various components, including facility operations and procedures.

There are existing techniques for familiarizing a user with the various operations, procedures, and equipment within a facility. One such technique, Automatic Identification and Data Capture techniques (AIDC), includes Quick Response (QR) Code or other sensing technologies such as Radio-Frequency Identification (RFID). The QR Code is a type of two-dimensional (2D) and optically machine-readable barcode that may be attached to a component. In order to access the information encoded within the QR Code, a specially programmed scanner may be utilized to read to the QR Code.

RFID technology uses radio waves to store and retrieve electronic data from an identification chip, e.g., RFID tags, attached to a component. To determine the contents of the electronic data, a RFID reader must be utilized. The RFID reader transmits an encoded radio signal to interrogate the tag and the RFID tag responds with its identification and other information. As detailed, the aforementioned AIDC methods must utilize either a scanner or reader and be placed at various checkpoint locations in order to obtain the embedded coded data for later use by a user.

U.S. Patent Application Publication No. 2002/0067372 by Friedrich et al. discloses augmented reality-based technologies to provide situation-related assistance to a skilled operator from remote experts. Friedrich relates to utilizing expert knowledge at a remote location, wherein data, for example in the form of video images, are transmitted by augmented-reality means from a first location occupied by a skilled operator to a remote expert at a second location. The remote expert transmits additional information data in the form of augmented-reality information to the skilled operator at the first location.

U.S. Pat. No. 6,356,437 by Mitchell et al. discloses a portable instruction customizable maintenance support instruction system. The system may be worn by a user and may include a lightweight computer in which a memory has been connected. The system includes a display device that may receive display signals from the computer for visual display to the user and an input device by which the user enters commands to the computer. An instructional program may store information in memory, in response to a user command, and display information concerning a task to be performed by the user on the display device in response to commands from the user.

U.S. Pat. No. 7,372,451 by Dempski discloses a system for displaying data and detecting visual markers within view of a wearable camera worm by a human operator. The system also determines the environmental status and displays data associated with at least one of the visual markers based on the environmental status on a see-through wearable display worn by the operator. Another aspect of Dempski provides coordinating the movement of human users including detecting one or more visual markers within view of a camera worn by the user, and determining the location of the user from a stored location of the visual marker within view of the camera.

International Patent Publication WO 2007/066166 by Skourup et al. discloses processing and displaying control instructions and technical information for an equipment, plant, or process in an industrial facility. A software entity may be configured with identities of the selected equipment, facility, or processes. The software entity may also be configured to retrieve information associated with the equipment, plant, or process. The information may be combined and annotated on a display device to provide control or maintenance instructions.

The aforementioned technologies and other similar techniques exist to provide technical information and data to a user through dissociated interaction with the environment. In particular, a user may access information in a facility with the aid of a scanner, which may then relay information associated with the environment back to the user. The current state of the technology merely provides manual manipulations or remote access before a user may view or display the associated data. Thus, it is desired to provide a display of a work environment for real-time view by a user while allowing the user to complete a field procedure associated with the work environment.

### SUMMARY

An embodiment disclosed herein provides a method of providing users with an augmented view of a work environment. The method includes downloading data relevant to a component in the work environment onto a mobile device. The work environment is navigated to locate the component based on prompts provided by the mobile device. An augmented reality (AR) marker located proximate to the component is scanned with the mobile device to access interactive procedures relevant to the component. One or more of the interactive procedures are performed.

Another embodiment provides a system for providing a real-time view of a work environment on a display. The system includes a mobile device that includes a processor, a camera, a touch screen display, and a storage system. The storage system includes an augmented reality (AR) system, a location module, a context awareness module, and a graphical user interface (GUI). The location module is configured to direct the processor to determine a location for the mobile device. The context awareness module is configured to confirm that the location is correct. The GUI is configured to display a real-time image of the work environment on the touch screen display and overlay augmented reality (AR) graphics over the real-time image utilizing the AR system.

Another embodiment provides a mobile device. The mobile device includes a processor, a camera, a touch screen display, and a storage system. The storage system includes an augmented reality (AR) system, a location module, a context awareness module, and a graphical user interface (GUI). The location module is configured to direct the processor to determine a location and orientation for the mobile device in a work environment. The context awareness module is configured to confirm that the location is correct and identify interactive procedures for the location. The GUI is configured to display a real-time image of the work environment on the touch screen display and overlay the interactive procedures over the real-time image utilizing the AR system.

### DESCRIPTION OF THE DRAWINGS

The advantages of the present disclosure are better understood by referring to the following detailed description and the attached drawings, in which:

FIG. 1 is a drawing of a work environment, in which a user is utilizing a mobile device in a facility in accordance with an embodiment of the present disclosure;

FIG. 2 is a schematic diagram of an augmented reality (AR) system in accordance with an embodiment of the present disclosure;

FIG. 3 is a schematic diagram of another AR system in accordance with an embodiment of the present disclosure;

FIG. 4 is a block diagram of a mobile device that may be used to implement an AR system, such as shown in FIG. 2 or 3, in accordance with an embodiment of the present disclosure;

FIG. 5 is a process flow diagram of a method for using a mobile device, including an AR system, in a facility in accordance with an embodiment of the present disclosure;

FIG. 6 is a process flow diagram of a method for using a mobile device that includes an AR system, in a hydrocarbon facility in accordance with an embodiment of the present disclosure;

FIG. 7 is a drawing of a mobile device showing an image with an arrow overlaid over the work environment to show a direction the user should go to reach a component, in accordance with an embodiment of the present disclosure; and

FIG. 8 is an illustration of a user in a facility utilizing the mobile device, in accordance with an embodiment of the present disclosure.

### DETAILED DESCRIPTION

In the following detailed description section, specific embodiments of the present disclosure are described in connection with one or more embodiments. However, to the extent that the following description is specific to a particular embodiment or a particular use of the present disclosure, this is intended to be for exemplary purposes only and simply provides a description of the one or more embodiments. Accordingly, the disclosure is not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present disclosure is not limited by the usage of the terms shown below, as all equivalents, synonyms, new developments, and terms or techniques that serve the same or a similar purpose are considered to be within the scope of the present disclosure.

The term “augmented reality (AR)” refers to a technology that provides real-time, direct or indirect, viewing of a real-world environment whose elements are augmented, e.g., supplemented by computer-generated sensory input such as sound, video, graphics, or GPS data. AR is related to a more general concept called mediated reality, in which a view of reality is modified, or possibly even diminished rather than augmented, by a computer. As a result of using AR technology, the current perception of a user may be enhanced.

The term “augmented reality (AR) marker” refers to a physical component that when scanned or read provides information or a reference number to obtain supplementary information concerning a component with which the AR marker is associated.

The term “augmented reality (AR) system” refers to a technology system embodying augmented reality (AR). The AR system combines the interactive real world with an interactive computer-generated world in such a way that they appear as a single image on a display device. As discussed herein, an AR system may be used to provide interactive procedures, for example, for carrying out functions in a facility.

The term “component” refers to tangible equipment in a facility utilized to operate and/or manage a system or a process. For example, components in a facility may include production wells, injection wells, well tubulars, wellhead equipment, gathering lines, manifolds, pumps, compressors, separators, surface flow lines, production vessels, and pipelines, among other equipment that may be utilized to make the facility functional.

The term “device” refers to an electronic unit used in a computing system. For example, a device may include a global positioning system (GPS) receiver, a memory, a camera, and a wireless local area network (WLAN) receiver, among many others.

The term “facility” refers to an assembly of components that is capable of storing and/or processing a raw material to create an end-product. Facilities may include refineries, chemical plants, field production systems, steam generation plants, processing plants, LNG plants, LNG tanker vessels, oil refineries, and regasification plants.

The term “hydrocarbon” refers to an organic compound that primarily includes the elements hydrogen and carbon, although nitrogen, sulphur, oxygen, metals, or any number of other elements may be present in small amounts. As used herein, hydrocarbons may include components found in natural gas, oil, or chemical processing facilities.

The term “hydrocarbon facility” refers to tangible pieces of physical equipment through which hydrocarbon fluids are produced from a reservoir, injected into a reservoir, processed, or transported. In its broadest sense, the term is applied to any equipment that may be present along the flow path between a reservoir and its delivery outlets.

The term “interactive” refers to allowing a user to have a real-time response with a system to be able to interact with the system in an effective manner.

The term “module” indicates a portion of a computer or information processing system that performs a specific function. A module generally includes software blocks that direct a processor to perform a function. It can be understood that the modules described in the examples herein are not limited to the functions shown, but may be assembled in other combinations to perform the functions described in the attached claims.

The term “procedures” refers to written materials explaining how to perform a certain task in a facility, how to safely work in a facility, how to safely work with hazardous substances in a facility, how to handle operability issues in a facility, among other issues related to the operations of a facility.

The term “real-time” refers to a technique whereby events are depicted as occurring substantially within the span of and at the same rate as the depiction. For example, depending on the speed of an event, this may be with a lag time within the time frame of a refresh rate for a control console of less than about two minutes, less than about one minute, less than about 30 seconds, less than about 15 seconds, or less than about five seconds.

The term “tracking technology” refers to a system for the observation of persons or components on the move and supplying a real-time ordered sequence of respective location data to a model, e.g., capable to serve for depicting the motion on a display capability. Some types of tracking technology may include geographic information systems (GIS), global positioning system (GPS), radio frequency identification (RFID), wireless local area network (WLAN), digital cameras, wireless sensors, accelerometers, gyroscopes, and solid-state compasses.

The term “user,” “field operator”, “operator” refers to a single individual or a group of individuals who may be working in coordination in a facility.

Methods and systems are provided herein for an augmented reality (AR) system that provides users with interactive procedures within a real-time view of a work environment, e.g., a facility. More specifically, the AR system may include a mobile device. The mobile device may provide a user with access to interactive procedures and other data relevant to a component in a facility.

Augmented Reality (AR) technology, such as image recognition and location sensing technologies, gives a user the ability to overlay augmented reality (AR) graphics onto a real-time image of a component in a facility. In other words, AR technology may provide a real-time view of a work environment that is augmented by computer generated sensory input, including sounds, video, graphics, or GPS data, and viewed on a visual display. By implementing computer vision and component recognition, AR technology transforms a visual display of the actual surroundings into interactive displays that provides enhanced information to a user.

The AR system may formulate the interactive procedures that may be displayed on the AR mobile device in real-time view from information stored in databases. The databases may include 3D graphical information related to operational procedures. The AR system may also embody location sensing and visual verification techniques to determine locations associated with the interactive procedures. The AR system may also provide verification for the completion of all successive steps associated with a particular interactive procedure. The verification process may include comparing data in a database with data associated with context awareness.

As discussed herein, the AR system may facilitate overlaying graphical information on a real-time view of the work environment. Thus, with the help of an AR system, including computer vision and component recognition, information about the surrounding real-world environment of a user becomes interactive when viewed on the mobile device.

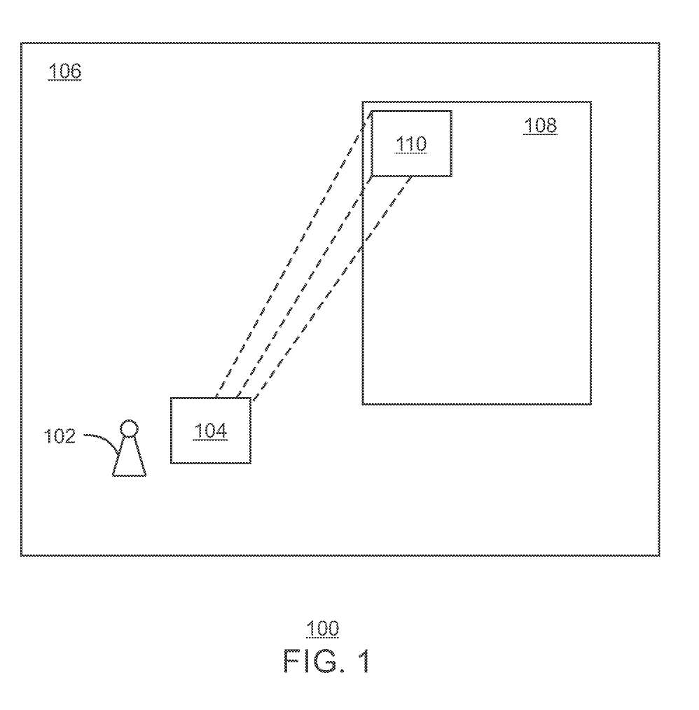

FIG. 1 is a drawing of a work environment 100, in which a user 102 is utilizing a mobile device 104 in a facility 106 in accordance with an embodiment of the present disclosure. The term production, as herein used, may be defined as a method for making or producing a product. In general, the production process takes inputs, e.g., raw-materials, and converts the inputs into a different material, or product. As shown in FIG. 1, the facility 106 may embody any type of process including chemical production, oil and gas production, power production, or any type of facility that produces a product. In the facility 106 of FIG. 1, a component 108, e.g., a production vessel, may be one of many components that make-up the facility 106. The component 108 may be associated with a proximate AR marker 110. The AR marker 110 may be encoded with information related to the component 108 that may be accessed by the user 102, such as a field operator. The mobile device 104 may overlay the real world and on-screen augmented reality outputs so that the display space of the mobile device 104 includes images that represent both the physical surroundings and a digital augmentation of the physical surroundings. This may provide the user 102 with a closely mapped virtual 2D or 3D visual guide layered on top of the image of the component 108, for example, at different perspectives or angle when the user scans the AR marker 110 with the mobile device 104.

The AR marker 110 may be one of a series of specially developed AR markers that may be mounted proximate to different components at various locations within the facility 106. In FIG. 1, AR marker 110 is mounted directly on the component 108. However, as used herein, proximate to a component means the AR marker 110 may be placed on the component, on a plaque near the component 108, on the ground near the component 108, or in any number of convenient locations that clearly indicate the relationship between the AR marker 110 and the component 108. In some embodiments, components that are located above the workspace, such as pipes, surge tanks, and vessels, among others, may have an AR marker 110 located on the ground below the associated component 108. The reading of an AR marker 110 may provide information about a particular component 108 and its interconnections within the facility 106, such as piping, adjacent vessels, operations, and the like. The AR marker 110 may provide a key (e.g., index number, barcode) that is used by the mobile device 104 to locate information about the component in a database. The AR marker 110 may contain encoded information about the component 108 in addition to, or instead of, any key.

In FIG. 1, the user 102 is provided with the mobile device 104 which is configured with a mobile AR system. As previously stated, the AR technology may give the user 102 the ability to overlay graphical data onto a real-time view of the component 108 for display on the mobile device 104, for example, enabling the user to access visual aids to proceed through a particular field procedure. Thus, the view of the facility 106 on the mobile device 104 may be interactive and manipulable by the user 102.

The user 102 can point the mobile device 104, which may incorporate a camera directly toward the AR marker 110 to access the data encoded within the AR marker 110, or to access data about the AR marker 110 based on a key stored in the AR marker 110. The camera may work in concert with other tracking technologies such as wireless sensors, accelerometers, global positioning systems (GPS), gyroscopes, solid-state compasses, or any combination of tracking sensors, to identify the location and orientation of the mobile device 104 and the component 108. In the example of FIG. 1, the camera can scan the AR marker 110 to capture and convert the encoded data read by the AR marker 110 into a file to be downloaded onto the mobile device 104. The file may contain data that is relevant to the component 108 and may be instantly viewed or stored onto the mobile device 104 by the user 102.

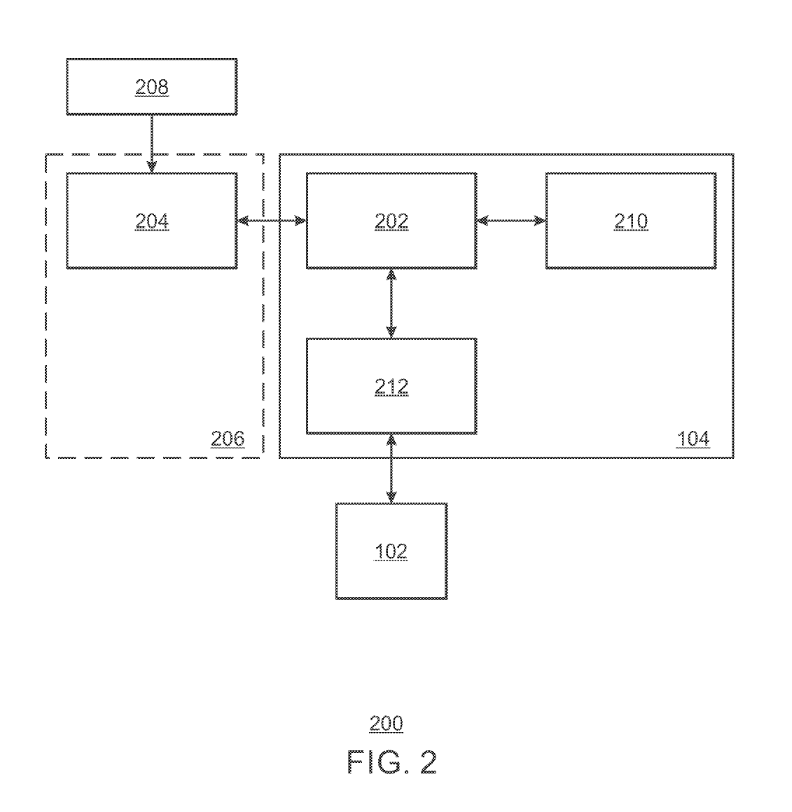

FIG. 2 is a schematic diagram of an augmented reality (AR) system 200 in accordance with an embodiment of the present disclosure. Like numbers are as described with respect to FIG. 1. A mobile AR system 202 may be included within the mobile device 104 of FIG. 1. A database 204 may be included in the AR system 200 to provide data to the mobile AR system 202. The database 204 may reside within a server 206 located, for example, in a control room or at a remote location connected via a network. As shown in FIG. 2, the database 204 may be loaded with data 208 including operating procedures, manuals, checklists, and other scanned or digitized materials. Further, the database 204 may include computer aided design (CAD) models, images, videos, or animation to provide users with guidance and knowledge concerning operational and procedural requirements related to a facility. For example, the database 204 may include operating procedures related to starting up a facility, shutting down a facility, isolating pieces of equipment for maintenance, or operating during emergency situations.

The mobile device 104 may include a context awareness module 210 configured to interact with the mobile AR system 202. The context awareness module 210 may work with other modules to obtain a location for the mobile device 104 in the work environment 100 through tracking technologies, such as a GPS receiver or other location sensors. The context awareness module 210 may also provide visual verification of the location using images captured by tracking technology within the mobile device 104. The context awareness module 210 may ensure that a user is in the correct location to display interactive procedures 212 for a component. The interactive procedures 212 for the component may be downloaded and stored in the mobile device 104 while it is connected to the database 204 over a physical network, before the user 102 enters the work environment 100. The interactive procedures 212 may also be downloaded while the user 102 is in the work environment 100, for example, through a wireless network. The context awareness module 210 may also determine the alignment of the mobile device 104 and a component of the plant, such as a component 108 (FIG. 1) in real time. In this way, the position and orientation between the mobile device 104 and the production vessel (not shown) may allow the mobile AR system 202 to determine the specific interactive procedures 212 for the location.

The interactive procedures 212 may include information from the database 204. The interactive procedures 212 may also provide results or updated information to the user 102. For example, operating procedures or 3D models of the database 204 may be provided to a user 102. Based on information, the database 204, and the context awareness module 210, the mobile AR system 202 may determine what information is relevant to the user 102.

The mobile device 104 is not limited to the devices and modules described, but may include any number of other devices. For example, accelerometers may be included to allow the device to determine orientation. This information may be used by the location module to determine the orientation of the device relative to the components of the facility.

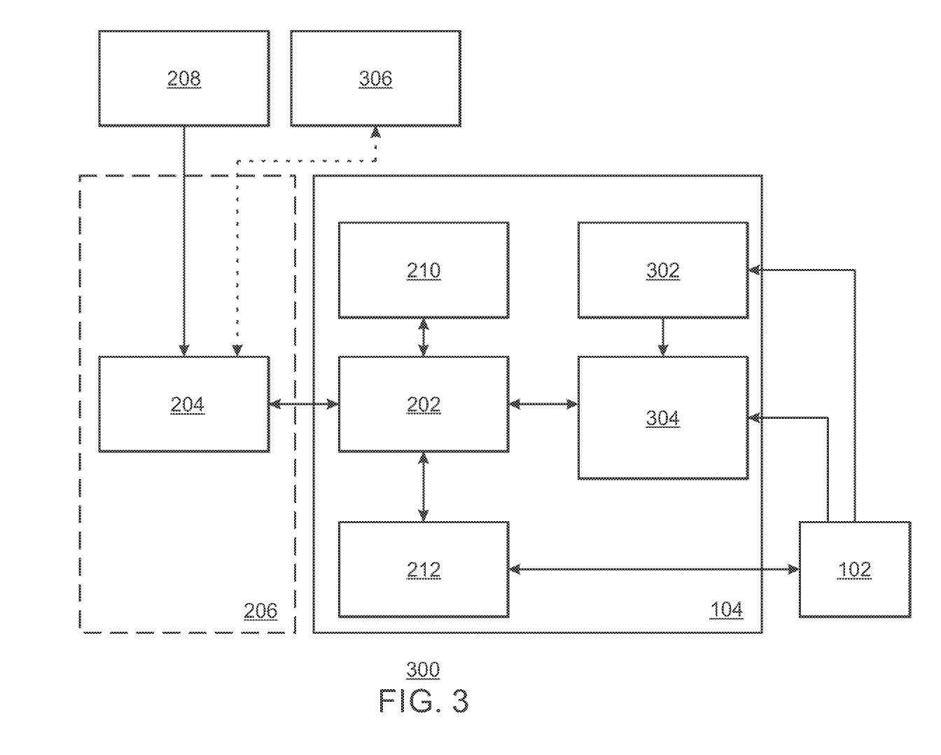

FIG. 3 is a schematic diagram of another AR system 300 in accordance with an embodiment of the present disclosure. Like numbered items are as described with respect to FIGS. 1 and 2. In addition to the database 204, the context awareness module 210, and the interactive procedures 212, the mobile device 104 may also include a note-taking module 302 and a work log module 304. Both the note-taking module 302 and a work log module 304 may be specific tasks that interact with other the modules of the mobile device 104.

The note-taking module 302 may allow the user 102 to record text, images, video, or voice observations in the work environment 100. The notes of the user 102 may be sent to a storage unit, such as the database 204 in the server 206, or held in the mobile device 104 for later uploading. The notes may be accessed or displayed from a control room 306. Based on the observations, actions may be proposed and sent to the mobile device 104. In an embodiment, the notes uploaded from the note-taking module 302 may be automatically tagged to a particular location within the facility and to specific interactive procedures in the database 204, allowing a user 102 to access the notes during future implementations of the procedure.

The work log module 304 may record information related to the actions of the user 102 including work done, time taken, date and time, and user identification information. To facilitate the most current information related to the work environment of the facility, the work log 304 may be synchronized with the database 204, either in real-time through a wireless network, or upon returning the mobile device 104 to a base station located in the control room 306.

The mobile device 104 may include any number of systems including, for example, phones and tablets running the iOS operating system from Apple or the Android operating system from Google. In some embodiments, other equipment may be used in conjunction with these devices, such as head mounted devices and eyewear, wearable smart watches, among others.

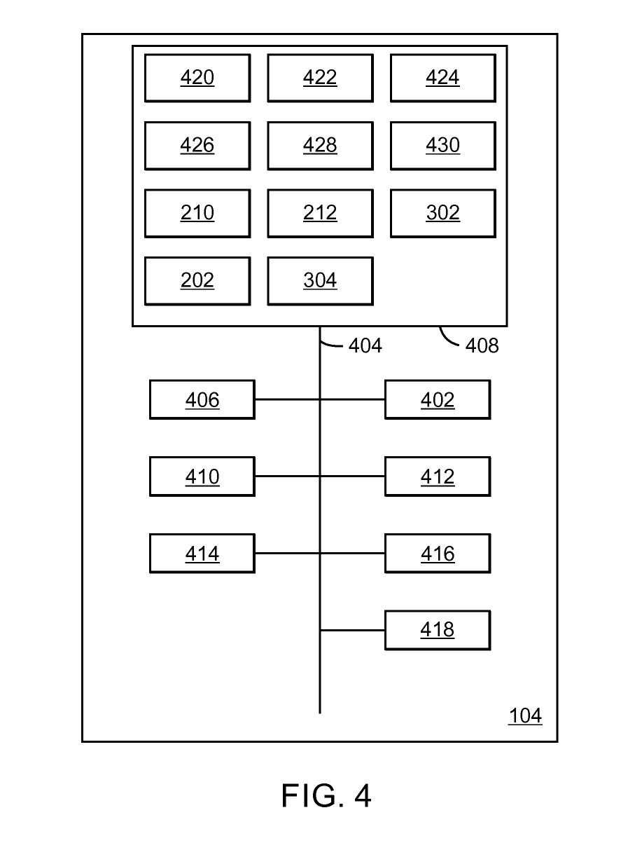

FIG. 4 is a block diagram of a mobile device 104 that may be used to implement an AR system, such as shown in FIG. 2 or 3, in accordance with an embodiment of the present disclosure. Like numbers are as described with respect to FIGS. 1-3. The mobile device 104 may include a processor 402 that can access various units over a bus 404. The bus 404 is a communication system that transfers data between various components of the mobile device 104. In examples, the bus 404 may be a PCI, ISA, PCI-Express, HyperTransport®, NuBus, a proprietary bus, and the like. The processor 402 can be a single core processor, a dual-core processor, a multi-core processor, a computing cluster, or the like, and may include a graphics processing unit (GPU) in addition to, or instead of, other processors.

The processor 402 may access a memory 406 over the bus 404. The memory 406 may store programs and data for immediate operations. The memory 406 can include random access memory (RAM), e.g., SRAM, DRAM, zero capacitor RAM, eDRAM, EDO RAM, DDR RAM, RRAM, PRAM, read only memory (ROM), e.g., Mask ROM, PROM, EPROM, EEPROM, flash memory, or any other suitable memory systems. In some embodiments, the memory 404 may be non-volatile, allowing it to function as a storage device for the mobile device 104. In other embodiments, a separate storage system 408 may be coupled to the bus for long term storage of software modules. The storage system 408 may include any number of non-volatile memory technologies, such as a solid-state disk drive (SSDD), an optical drive, a hard drive, a micro hard drive, and the like.

The processor 402 may access a network interface card (NIC) 410 over the bus 404. The NIC 410 can be used to directly interface with a network, for example, via a cable. The NIC 410 can provide high speed data transfer allowing fast downloading of large amounts of data, such as three dimensional graphic primitives, as described herein. A wireless local area network (WLAN) transceiver 412 can allow the mobile device 104 to access data from remote locations, for example, during operation in the work environment 100.

The mobile device 104 may include any number of other hardware devices to provide the functionality for the AR system. For example, a global positioning system (GPS) receiver 414 may be included to provide location data to the mobile device 104. As described herein, the location data may be used to find a component in a work environment. A camera 416 may be included to identify AR markers 110 positioned proximate to components. A touch screen display 418 may be coupled to the bus to provide a human-machine interface for interacting with the mobile device 104.

The storage system 408 may contain software modules configured to provide the augmented reality functionality to the mobile device 104. The software modules include code that can direct the processor 402 to use the camera 416 in conjunction with tracking technology to provide information about various components in the work environment. For example, the software modules of the mobile device 104 may include a 3D rendering module 420, a location module 422, a graphical user interface (GUI) 424, photographic data 426, 3D graphical primitives 428, a calibration module 430, the context awareness module 210, the mobile AR system 202, the interactive procedures 212, the note-taking module 302, and the work log module 304.

Rendering software draws an image on a display based on simple objects, termed primitives. The 3D rendering module 420 includes code that directs the processor to render or display images in a 3D format, e.g., having the correct location and orientation to overlay camera images of the environment that are displayed on the touch screen display 418.

The location module 422 may direct the processor 402 to access the GPS 414, camera 416, and other systems, such as the WLAN 412, to determine the location of the mobile device 104. Further, the location module 422 may use image recognition technology to identify markers and components in the work environment. For example, the location module 422 may include a bar code reader and image analysis code such as corner detection, blob detection, edge detection, and other image processing methods.

As described herein, the context awareness module 210 may use the information from the location module 422 to determine the position and orientation of components in the environment relative to the mobile device 104, for example, to place appropriate graphics over the image of the component using the 3D rendering module 420 or to superimpose procedural instructions over the image using a graphical user interface (GUI) 424. Similarly, the position and orientation may be used to place input buttons, prompts, procedural instructions, and other graphical enhancements in the correct positions near the component.

The GUI 424 may display the real-time image of the work environment 100 and any AR enhancements overlaying the real-time image. For example, the GUI 424 may be used to select and overlay step-by-step instructions for interactive procedures on a display of the mobile device 104. Photographic data 426 may be accessed by the GUI 424 to display related images or videos, for example, generated to show details of procedures, or recorded during previous operations. As well as providing operating procedures, the GUI 424 may allow the user 102 to access system and engineering data, instrumentation and control (I&C) charts, piping and instrumentation diagrams (P&IDs), process flow diagrams (PFDs), operating envelopes, critical performance parameters, plot layouts, 3D models of process equipment with exploded component views, video tutorials, and any other types of digital data useful to a user 102 in performing the selected procedure.

The calibration module 430 may be used for the calibration of the image recognition features. The calibrated parameters may be saved locally on the device 104 and accessed by the location detection module 422, the GUI 424, or any other systems during any subsequent usages. The interactive procedures 212, the note-taking 302, and the work log 304, are as described with respect to FIGS. 2 and 3.

The system diagram of FIG. 4 is not intended to indicate that all modules and devices shown are required in every implementation. Further, other modules may be included. Depending on the details of the specific implementation, additional components may be included. For example, the mobile device 104 may be constructed to be “explosion proof,” and certified for various operations and used, either temporarily or permanently, in electrically classified areas in a facility.

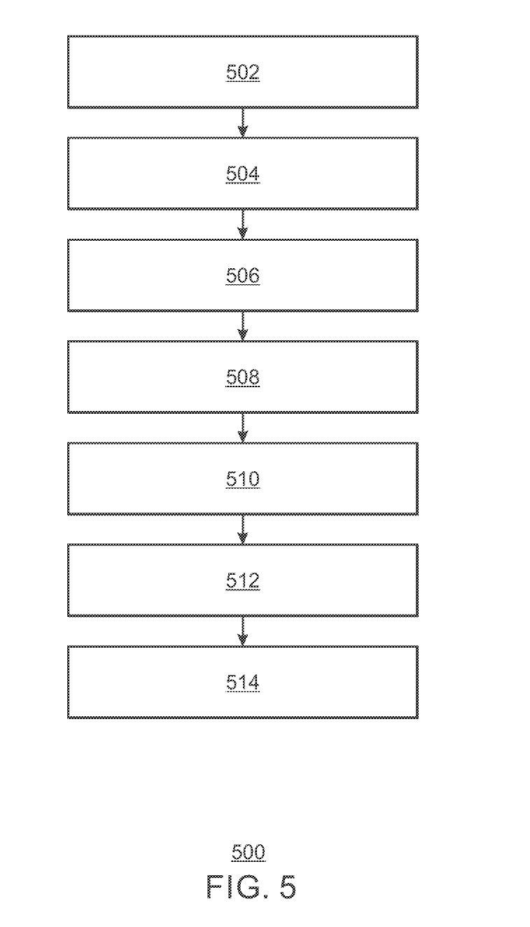

FIG. 5 is a process flow diagram of a method 500 for using a mobile device, including an AR system, in a facility in accordance with an embodiment of the present disclosure. The method 500 begins at block 502 with the placement of an augmented reality (AR) marker proximate to a component in a work environment of the production facility. The AR marker is a graphical device, such as a bar code, a QR code, or the like, which may be utilized to locate information in a database about the component. AR markers may be placed proximate to various components in a facility to locate and to provide relevant information related to each component.

At block 504, data may be downloaded to a mobile device, such as a mobile computing tablet, from a database. The data may include operating procedures, instructions, 3D graphic primitives, and visual aid materials to display interactive procedures on the mobile device. As used herein, an interactive procedure is an ensemble of information presented to a user for a work procedure. At block 506, a user may select an interactive procedure on the mobile device. Based on the data downloaded to the mobile device, the AR system may decide what information to present to the user in the form of the selected interactive procedure. The selected procedure may contain textual and 3D visualization of the facility to guide the user during completion of the procedure steps. In various examples, the mobile device may include tracking technology, such as an installed digital camera. The digital camera may be utilized to scan and read an AR marker proximate to the component to locate data or a position in a plant. The encoded data may provide relevant information related to the component. For example, an AR marker on a production vessel may locate identification information, schedule maintenance information, or performance parameter ranges related to the vessel.

At block 508, the user may navigate through the work environment of the facility by following successive prompts generated by the AR system and displayed on the mobile device. At block 510, based on the prompts, the user may be directed to a component marked with a particular AR marker. At block 512, a prompt may instruct the user (e.g., field operator) to scan the AR marker using the tracking technology of the device. A prompt may then confirm that the correct location has been reached for the particular component within the work environment. At block 514, the user may perform operations and record observations during a series of successive prompts. The work flow may also be logged during completion of the procedure. The method is not limited to that shown in FIG. 5, as any number of configurations and other method steps may be used in embodiments.

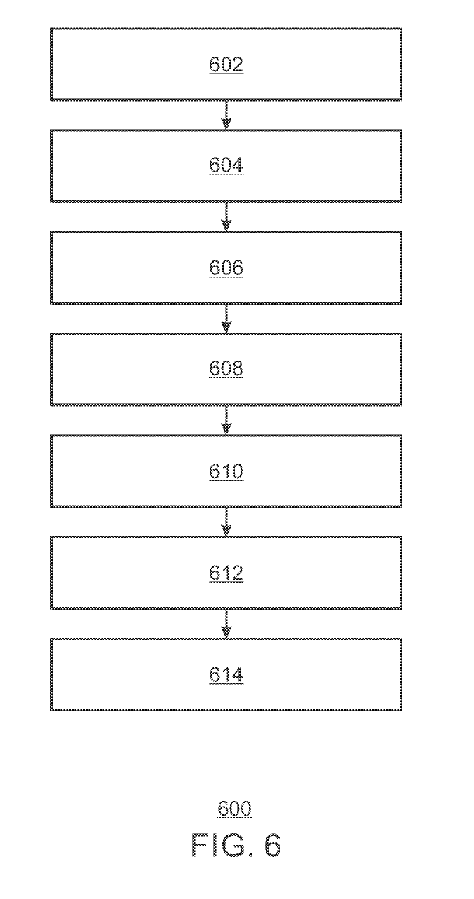

FIG. 6 is a process flow diagram of a method 600 for using a mobile device that includes an AR system, in a hydrocarbon facility in accordance with an embodiment of the present disclosure. While a user may be trained in a theoretical and practical manner, it may be difficult to become acquainted with every nuance of a facility. Thus, an AR system may assist the user in learning the facility and executing procedures.

The method 600 begins at block 602 where an augmented reality (AR) marker may be placed proximate to a component in the work environment. As described herein, proximate to an object means the AR marker may be placed in any number of convenient locations that clearly indicate the relationship between the AR marker and the object.

At block 604, data may be downloaded onto an AR mobile device, wherein the data comprises procedural and graphical data about the component. The data may also include written operational instructions, procedures, checklists, and visual aid material pertaining to the work environment. Additionally, the AR mobile device may include tracking technology, e.g., an installed camera, utilized by the user to locate information related to the component. At block 606, the user may power-on the AR mobile device and select a procedure from the data via the AR mobile device. The procedure may be an interactive procedure generated in digital form to provide a real-time view of the work environment. In particular, the procedure may provide a view of the environment augmented by computer generated sensory input, such as sounds, video, graphics, or GPS data, computer vision, and component recognition. Thus, the actual surroundings of the work environment as displayed on the mobile device may become interactive so that components within the environment may be manipulated via the mobile device.

At block 608, the interactive procedure may provide a prompt to locate a particular component in the work environment. The prompt on the mobile device may lead the user to the component by highlighting real world features within the work environment, as displayed on the mobile device. At block 610, once the proper location of the component has been reached, the user may scan the AR marker located proximate to the component using the installed camera. The AR system may provide the user with the ability to determine if the location is correct by verifying the location using locating sensing data and visual verification data. At block 612, the operator may continue to obtain procedural prompts from the mobile device related to the selected procedure. At block 614, the user may continue to follow successive procedural prompts until completion of the interactive procedure. The method is not limited to that shown in FIG. 6, as any number of configurations and other method steps may be used in embodiments.

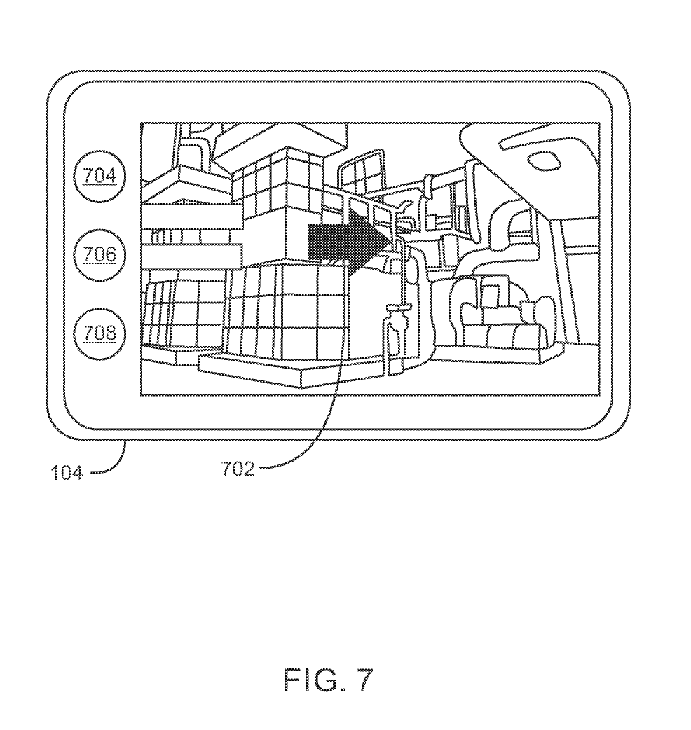

FIG. 7 is a drawing of a mobile device 104 showing an image with an arrow 702 overlaid over the work environment to show a direction the user should go to reach a component, in accordance with an embodiment of the present disclosure. Like numbered items are as described with respect to FIG. 1. Additionally, the mobile device 104 may include an intuitive user interface so as to facilitate ease of usage. For example, a first button 704 may enable or disable the guidance, a second button 706 may access a control screen for downloading the procedures, and a third button 708 may access a control screen that allows the selection and operation of interactive procedures. These identifications are merely examples of controls that may be used, as any number of functions could be included and accessed in other ways. For example, the arrow 702 may be configured as a button that controls the operation of the navigation. Touching the screen starts the navigation and touching the arrow 702 ends the navigation.

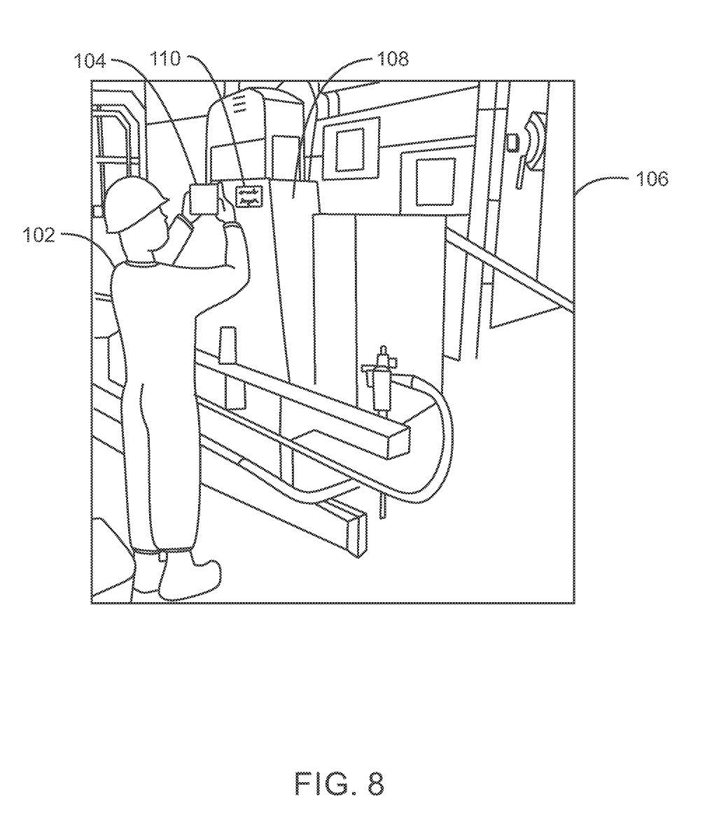

FIG. 8 is an illustration of a user 102 in a facility utilizing the mobile device 104, in accordance an embodiment of the present application. Like numbers are as described with respect to FIG. 1. A case scenario may be provided to clarify the step-by-step approach that a user 102, e.g., an operator, may take to complete a selected interactive procedure using the mobile device 104. As described herein, an AR system may be configured on the mobile device 104, for example, as described with respect to FIGS. 1 and 2. The mobile device 104 may be a mobile computing device, such as a mobile tablet or any lightweight device that includes tracking technologies. The mobile device 104 may be portable and configured as a hand-held device that may allow the user 102 to walk through a facility 106, e.g., a work environment 100, while displaying a virtual model of the facility and performing successive steps of an interactive procedure.

To begin, the operator 102 may power-on the mobile device 104 and select a specific interactive procedure from a built-in database. The operator 102 may then follow any visual and textual prompts displayed by the interactive procedure on the mobile device 104. A visual map of the facility 106 displayed on the mobile device 104 may direct the operator 102 to approach a physical location to perform a first step of the interactive procedure. In some embodiments, this may include an initial prompt that may be displayed on a visual map to direct the operator 102 to locate a specific piece of equipment in the facility 106. The visual map displayed on the mobile device 104 may include a 3D display of the entire facility 106 or only a limited area within the facility 106. The operator 102 may be allowed to toggle between these views to locate the component.

Once the operator 102 arrives at the location of the component 108, an AR marker 110 proximate to the component 108, e.g., a production vessel, pipe or other unit, may be observed. The operator 102 may direct a camera of the mobile device 104 towards the AR marker 110 to allow the mobile device 104 to decode the AR marker 110 and use the information as a key for locating the procedures related to the component, directly use information encoded in the AR marker 110, or both.

Once the AR marker 110 is decoded, the AR system may verify that the location of the operator 102 is the correct location. Further, the AR system may retrieve any relevant information related to the component. The AR system may also identify any additional components associated with that particular step of the procedure. For example, the AR system may provide data related to critical fluid levels, pressures, and temperatures concerning a component that may be part of a particular step in the procedure.

The operator 102 may then proceed through the steps of the procedure by following successive prompts displayed on the mobile device 104. More specifically, the operator 102 may be then guided through each step of the procedure in an interactive manner. As described herein, the mobile device 104 may display textual prompts, photos, videos, and 3D models overlaid on actual field equipment to aid the operator 102 in completing all steps of the interactive procedure. After each step is completed, the operator 102 may be given permission to continue to the next step of the interactive procedure. Thus, the operator 102 may complete the steps of the interactive procedure. In some embodiments, the mobile AR system may be configured to allow the operator 102 to proceed to the next step only after a proceeding step is successfully completed. Thus, the operator 102 may not skip a step or return to a previously completed step of the interactive procedure.

The AR system on the mobile device 104 displays a real-time view of the work environment 100 to assist the operator 102 in completing the interactive procedure. Thus, the AR system may provide a combined image of a real-time view with overlaid information generated by the mobile device 104. For example, the combined image may include additional information and instructions displayed over the related component 108. In the facility 106, the AR system may facilitate the completion of maintenance or operational procedures, as well as providing knowledge and training for an end-user. The procedural steps and arrangement of the procedural steps are not limited to those as discussed with respect to FIG. 8, as the number of steps may vary based on the details of the specific implementation.

As described herein, the AR system may be configured on a hardware system that includes such mobile devices 104 as smartphones and tablet computers. In a facility, the mobile device may provide a user with an enhanced view of the surroundings and facilitate training users in an interactive system. For example, the mobile device 104 in the AR system may provide a user with the ability to overlay graphical data, e.g., arrows, proceed, caution, or stop signs, onto a component in the facility and thus, may facilitate the completion of interactive procedures related to that component. The mobile device 104 may also provide verification of each step taken in the procedure by the user and identification of any observations associated with the steps. Moreover, the mobile device may enhance coordination and communication between more experienced users and novice users in the context of performing maintenance or operations procedures in an actual work environment.

It should be understood that the preceding is merely a detailed description of specific embodiments of the invention and that numerous changes, modifications, and alternatives to the disclosed embodiments can be made in accordance with the disclosure here without departing from the scope of the invention. The preceding description, therefore, is not meant to limit the scope of the invention. Rather, the scope of the invention is to be determined only by the appended claims and their equivalents. It is also contemplated that structures and features embodied in the present examples can be altered, rearranged, substituted, deleted, duplicated, combined, or added to each other. The articles “the”, “a” and “an” are not necessarily limited to mean only one, but rather are inclusive and open ended so as to include, optionally, multiple such elements.

What is claimed is:

1. A method of providing users with an augmented view of a work environment in a facility, comprising:
downloading data relevant to a component in the work environment onto a mobile device;
navigating the work environment to locate the component based on prompts provided by the mobile device;
scanning, with the mobile device, an augmented reality (AR) marker located proximate to the component to access interactive procedures relevant to the component; and
performing one or more of the interactive procedures.

2. The method of claim 1, comprising downloading an augmented reality system to the mobile device.

3. The method of claim 1, comprising accessing data on the component based, at least in part, on location data.

4. The method of claim 1, comprising providing an overlay over a real-time image of the work environment, wherein the overlay comprises interactive procedures relevant to the component in the real-time image.

5. The method of claim 1, comprising displaying a step in one of the interactive procedures, wherein the step is confirmed as completed before another step is provided.

6. The method of claim 1, comprising verifying a location within the work environment after locating the component.

7. The method of claim 1, wherein scanning the AR marker comprises decoding information in the AR marker.

8. The method of claim 1, comprising:
identifying the location of the mobile device; and
determining the orientation of the mobile device relative to the component.

9. The method of claim 1, wherein the data comprises operation procedures, manuals, checklists, animations of plant components, or any combinations thereof.

10. The method of claim 1, comprising recording observations, wherein the observations comprise notes, images, operating parameters, or any combinations thereof.

11. The method of claim 1, comprising logging a work flow during completion of one or more of the interactive procedures.

12. A system for providing a real-time view of a work environment on a display, comprising:
a mobile device, comprising:
a processor;
a camera;
a touch screen display; and
a storage system, comprising:
an augmented reality (AR) system;
a location module configured to direct the processor to determine a location for the mobile device in the work environment;
a context awareness module configured to confirm that the location is correct; and
a graphical user interface (GUI) configured to display a real-time image of the work environment on the touch screen display and overlay augmented reality (AR) graphics over the real-time image utilizing the AR system.

13. The system of claim 12, comprising a server, which server comprises a database, wherein the database comprises operating procedures, manuals, checklists, photographs, process flow diagrams, or operating parameters, or any combinations thereof.

14. The system of claim 13, wherein the database comprises three-dimensional (3D) graphics.

15. The system of claim 13, comprising a wireless local area network (WLAN), wherein the mobile device is configured to download information from the server over the WLAN.

16. The system of claim 13, comprising a network interface card (NIC) configured to download information from the server over a wired connection.

17. The system of claim 12, comprising a note-taking module configured to record observations.

18. The system of claim 12, comprising an augmented reality (AR) marker located proximate to a component in a facility, wherein the AR marker comprises information related to the component.

19. The system of claim 12, comprising interactive procedures, wherein the interactive procedures comprise operating procedures, computer aided design (CAD) models, images, videos, animations, or any combinations thereof.

20. The system of claim 12, comprising a work log module configured to record actions of a work flow during the operation of the mobile device.

21. A mobile device, comprising:
a processor;
a camera;
a touch screen display; and
a storage system, comprising:
an augmented reality (AR) system;
a location module configured to direct the processor to determine a location and orientation for the mobile device in a work environment;
a context awareness module configured to confirm that the location is correct and identify interactive procedures for the location; and
a graphical user interface (GUI) configured to display a real-time image of the work environment on the touch screen display and overlay the interactive procedures over the real-time image utilizing the AR system.

22. The mobile device of claim 21, wherein the location module accesses a global positioning system receiver and an accelerometer.
